(19) United States
(12) Patent Application Publication
(10) Pub. No.: US 2023/0234281 A1
(43) Pub. Date: Jul. 27, 2023

(54) METHOD FOR RADIATION-CURED RELIEF PRINTING ONTO CONTAINERS

(71) Applicant: Krones AG, Neutraubling (DE)

(72) Inventors: Alexandra LYASHENKO, Regensburg (DE); Peggy AUGST, Wackersdorf (DE)

(21) Appl. No.: 17/591,135

(22) Filed: Feb. 2, 2022

(30) Foreign Application Priority Data
Jan. 24, 2022 (DE) 102022101561.0

(51) Int. Cl. B29C 64/124; B33Y 40/20; B33Y 10/00

(52) U.S. Cl. CPC B29C 64/124; B33Y 40/20; B33Y 10/00; B33Y 80/00

(57) ABSTRACT

A method is described for radiation-cured relief printing onto containers, where at least two print layers are applied one on top of the other onto a container surface by way of an ink jet and are cured successively by way of irradiation in such a way that the print layers, in particular edge regions thereof, can run over one another and/or alongside one another. As a result, the height and contours of relief-like printed images can be adjusted flexibly and efficiently by radiation-induced limited smoothing.

### RELATED APPLICATIONS

This application claims the benefit under 35 U.S.C. § 119(a) of German Application No. DE102022101561.0 filed Jan. 24, 2022, the entire contents of which are hereby incorporated by reference.

### TECHNICAL FIELD

Embodiments of the present disclosure relate to a method for radiation-cured relief printing onto containers and a container printed onto in this manner.

### BACKGROUND

A method for radiation-cured relief printing onto containers in which several print layers are applied one on top of the other onto a container surface by way of an ink jet and are cured successively by way of irradiation is known from WO 2020/180478 A2. For this purpose, elevated structures are printed in multiple layers directly onto the container surfaces by half tone printing. The height of the elevated structures and their profile on their flanks descending towards the container surface then arises from the respective gray scale values of the print layers in the individual regions of the printed image to be produced. This means that regions that are printed with higher gray scale values result in correspondingly higher prints than in regions with comparatively lower gray scale values.

The disadvantage there is that such a half tone print requires a comparatively large number of print layers to produce the desired relief structures and is therefore comparatively expensive and/or is not suitable for full tone printing that may need to be carried out.

There is therefore a need for alternative methods for radiation-cured relief printing onto containers with which in particular at least one of the drawbacks mentioned can be avoided or at least mitigated.

### BRIEF DESCRIPTION OF THE DRAWINGS

Some embodiments of the present disclosure shall be illustrated by way of the drawings.

FIGS. 1A-C show a relief-like printed image with print layers of different thicknesses and the underlying layer build-up according to the print template;

FIGS. 2A and 2B show an alternative relief-like printed image with print layers that have run and the underlying layer build-up according to the print template; and

FIGS. 3A-C show variants of the layer build-up according to print templates; and

FIG. 4 shows an alternative printed image with a cover layer that has run.

### DETAILED DESCRIPTION

A method described herein may be used for radiation-cured relief printing onto containers, where at least two print layers are applied one on top of the other onto a container surface by way of an ink jet, for example, onto a side wall of a container, and are cured successively by way of irradiation in such a way that the print layers, in particular edge regions thereof, can run over one another and/or alongside one another. For this purpose, the print layers can be irradiated individually and/or together.

As a result, the height and contours of relief-like printed images can be adjusted flexibly and efficiently by radiation-induced limited smoothing. Due to the print layers being permitted to run at their edge regions over one another and/or alongside one another, thickness gradations at the edge regions predefined in an associated electronic template can be smoothed selectively, i.e., for example, flattened and rounded off. The thickness of the resulting print layers and the height of the printed images can thus also be influenced accordingly.

Print layers printed one on top of the other in this manner complement each other generatively to form relief-like surface structures. Their height and flank contour can be specifically influenced by allowing the edge regions to run. More pronounced running leads to thinner print layers with smoother flank contours and vice versa. In particular, undesirably pronounced stepped contours can be avoided. According to some embodiments of the present disclosure, this is also possible in full tone printing, i.e. without gray scale values in the region of relief flanks.

Relief printing is presently to be understood to mean that a relief-like printed image is produced on containers, such as bottles, cans, cups, drinking glasses, or tubes. For this purpose, print layers are layered onto one another by successively applying at least one ink, at least one varnish, and/or similar printing paint from at least one print head onto a container surface by way of jet application, i.e. according to the principle of inkjet printing. Elevated regions are therefore built up generatively on the container surface, the shape of which is smoothed by the print layers being permitted to run. Ultimately, this results in the relief elevations and optionally the relief depressions of the printed image.

The edges of the print layers therefore substantially build up the relief flanks of the relief elevations and/or relief depressions produced. In a top view onto the printed image, the edges can be rectilinear, beveled, convexly curved, and/or concavely curved. This means that relief flanks built up from the edges of the print layers can also form inner contours of the printed image, such as walls of crater-shaped relief depressions, walls of steep curve-like structures or the like.

The running/smoothing within a suitable period of time is limited by radiation-induced curing, which may be incomplete in the sense of a partial curing that controls the flow behavior of the print layers, which is also referred to as pinning. Curing the print layers then usually takes place by final irradiation only after the application of all print layers.

Starting out from the associated electronic print templates and a layer application stepped towards the edges from the perspective of printer control, the print layers then run outwardly and downwardly (towards the container surface) so that the resulting relief-like printed image is three-dimensionally smoothed compared to the print template. Depending on the layer build-up at the edges and the running permitted, the print layers can be used to build up, for example, rounded stepped relief flanks or such having a smooth flank contour, i.e. without any visually perceptible stepping. Visually smooth flank contours can be produced, for example, in that a print layer runs over the edges of several underlying print layers and thereby covers them.

Radiation-induced curing allows the print layers to run and therefore the thickness and flank contour of relief-like structures built up from the print layers to be controlled in a relatively flexible manner. The areal distribution and the height distribution of relief-like printed images on containers can be fundamentally specified by electronic print templates. Based on this, the height distribution can be smoothed by the permitted running and the edge sharpness of the two-dimensional distribution can be reduced accordingly.

At least two print layers may be applied to the container surface one on top of one another by way of an ink jet and are cured individually and/or jointly by way of irradiation in such a way that edge regions of the print layers can run over one another and/or alongside one another. In other words, print layers can first be printed one on top of the other and run to an extent permitted at their edge regions before they are pinned jointly in the manner described. Likewise, at least one of the print layers can be pinned individually immediately after it has been applied.

For example, depending on the dose of irradiation, the curing of individual print layers can cause them to run less pronounced, which results in greater layer thicknesses and in a printed image that is sharper when viewed from above. Conversely, joint curing of several print layers printed one on top of the another can cause them to run more pronounced, which results in thinner print layers and a printed image that is more blurred when viewed from above.

It goes without saying that radiation-induced pinning of individual print layers and joint radiation-induced pinning of several print layers previously printed one on top of the other can be combined with one another in any desired sequence.

At least one and in particular at least two of the print layers may be applied by full tone printing. As a result, comparatively high relief structures can be produced with a comparatively small number of print layers and their edges can be smoothed in a selective manner by their permitted running, for example, in order to produce fluently stepped or smooth-surfaced flank contours. Nevertheless, the method is also possible with half tone printing or as a combination of full tone printing and half tone printing.

In some embodiments, a first edge region of one of the print layers projects in a lateral direction over a second edge region of a print layer disposed directly beneath the first edge region in an associated electronic print template. Furthermore, the first edge region is then permitted to run towards the container surface in such a way that it covers the second edge region in full height. As a result, the contour of a relief flank built up by the first and second edge region can be smoothed to a particularly large extent. For example, the uppermost print layer can then overlay and cover the edge regions of several and in particular all print layers beneath the uppermost print layer in the form of a substantially stepless relief flank. As a result, particularly visually appealing relief structures can be produced with a visually smooth flank contour, i.e. without any visible stepping.

However, embodiments can also be advantageous in which a third edge region of the print layers is recessed laterally with respect to a fourth edge region of a print layer directly beneath the third edge region in an associated electronic print template. If the third edge region is then permitted to run outwardly and toward the container surface, a smoothed step contour arises, i.e. a relief flank with steps that are flattened and/or rounded on the outside. This can be advantageous for haptic reasons, for example, if non-slip relief structures are to be printed onto the container surface.

Also conceivable would be combined print templates with a layer build-up hanging over at the edge (first and second edge region above) and/or a layer build-up rising at the edge (third and fourth edge region above) and/or with a vertical layer build-up at the edge (edge areas terminating flush at the side).

Each of the print layers is associated, for example, with an in particular separate electronic print template which defines the regions of a printed image to be produced in which the respective print layer is to be applied and which regions of the printed image are omitted. This results in the respective lateral dimensions in the sense of a conventional two-dimensional print of the respective print layer. Furthermore, the print template can comprise information on the thickness of the respective print layer which may vary locally, in the sense of a region-specific amount of ink, varnish, or paint. If several print layers are printed with the same color and the same print head, then the print templates assigned layer by layer can be made available in a common file. In this regard, one could also speak of a common print template for several print layers.

On the basis of respectively associated electronic print templates, the print layers may form at least one relatively low printed image region with at least one print layer and at least one relatively high printed image region with a comparatively larger number of print layers in the sense of relief elevation and/or relief depression. This means that the height of relief elevations and the depth of relief depressions as well as their flank contours are determined, firstly, by the number of print layers printed one on top of another there and, secondly, by the smoothing as a result of their running. So-called embossings as well as so-called debossings can be produced comparatively flexibly in this way.

Debossings can be produced, for example, by printing the entire surface of the container in multiple layers in the printing region and omitting sunken regions, which are referred to as a debossing. Debossings therefore have a reduced number of print layers.

In some embodiments, at least one of the print layers is a paint layer and at least one of the print layers is a protective varnish layer. In this way, different optical and haptic effects can be provided on the relief structures produced by way of the printed fonts.

Irradiation durations and/or irradiation intensities for steps for the respective pinning of one or more of the print layers may be parameterized separately for the individual steps. The layering and smoothing of the relief-like structures at the respective edges, both with regard to their thickness and with regard to their contour, can then be set in a selective and comparatively flexible manner. Radiation intensity and irradiation duration can be controlled particularly easily and flexibly, for example, at LED light sources.

The print layers may be pinned by irradiation with light in the wavelength range from 10 to 460 nm and/or by way of an electron beam. Inks, paints, adhesives, and varnishes are available for respective layering and smoothing of print layers, in particular those that cure by UV light as well as those that cure by electron beams. The method according to some embodiments of this disclosure can therefore be used with a large number of inks, paints, and varnishes and therefore allows a great deal of freedom of design.

Time intervals between the application and the irradiation of the print layers may be set by adjusting the relative speed of the container surface with respect to associated print heads and radiation sources. If, for example, the relative speed of the container surface (and the printing speed) is increased, then the print layers can be pinned more quickly, as a result of which the edge regions run less than at lower relative speeds. As a result, the edge regions running and therefore the smoothing of the printed image produced can be additionally controlled. The time intervals could also be set by including an idle rotation (rotation without print or irradiation), for example, such a full turn, half turn, one third turn, quarter turn or other fractional turn. Idle multiple turns are also conceivable. In this way, print layers can be cured later/with a delay without changing the rotation and printing speed.

The containers may be rotated about themselves during the application and curing of the print layers, where their rotational speed for the irradiation is adapted, in particular separately from a rotational speed during jet application, to a viscosity and/or a flow behavior of the ink, varnish, or similar printing paint that is applied. The rotational speed can be used, firstly, to influence the relative speed of the container surface with respect to associated print heads and/or radiation sources, and, secondly, centrifugal forces induced during the rotation reduce the running of the print layers and therefore the smoothing of the printed image produced. For example, the thickness and the edge sharpness of the respective print layer can be increased by increasing the rotational speed and vice versa. As a result, the smoothing of individual print layers and/or the printed image formed therefrom can be additionally influenced overall.

The print layers may each have a thickness of from 1 μm to 200 μm, in particular from 10 μm to 125 μm. The total layer thickness of the print layers after curing is, for example, 1 μm to 10 mm, in particular 20 μm to 1 mm. A plurality of relief printed images can thus be produced for the decorative and/or haptic enhancement of container surfaces.

The thicknesses of the print layers may also be set by adjusting at least one of the following parameters of the inks/paints/varnishes used: viscosity; surface tension; ejection temperature; ejection speed; droplet size or droplet volume at ejection; and rate of curing per dose of irradiation; and/or curing time per dose of radiation, and/or by adjusting the time between printing and pinning (time-to-pin). For example, the edge regions of the print layers running over one another and/or alongside one another can be adapted by adapting the irradiation to the properties of the inks/paints/varnishes defined by at least one of the parameters mentioned above.

The print layers may be applied during the continuous transport of the container, in particular on a container carousel, by way of print heads which are stationary in relation thereto.

Accordingly, suitable for carrying out a method according to some embodiments of this disclosure is, for example, a device including: a transport device with holders for the containers which are arranged in particular circumferentially thereon and are rotatable about themselves; print heads each for jet application of at least one print layer to each of the containers; and radiation sources for pinning individual and/or multiple print layers. Furthermore, the device further includes, for example, a programmable control system for controlling the holders, print heads, and radiation sources in dependence of electronic print templates for applying the print layers one on top the other and cure them such that edge regions of the print layers in dependence thereof can run over one another and/or alongside one another. Containers printed in a relief-like manner having the advantages described can thus be produced.

The container according to some embodiments of the present disclosure is in particular a bottle, a can, a cup, a drinking glass, or a tube and is used to receive liquid end products such as food. The container includes a relief-like printed image applied using a method according to at least one of the embodiments described herein.

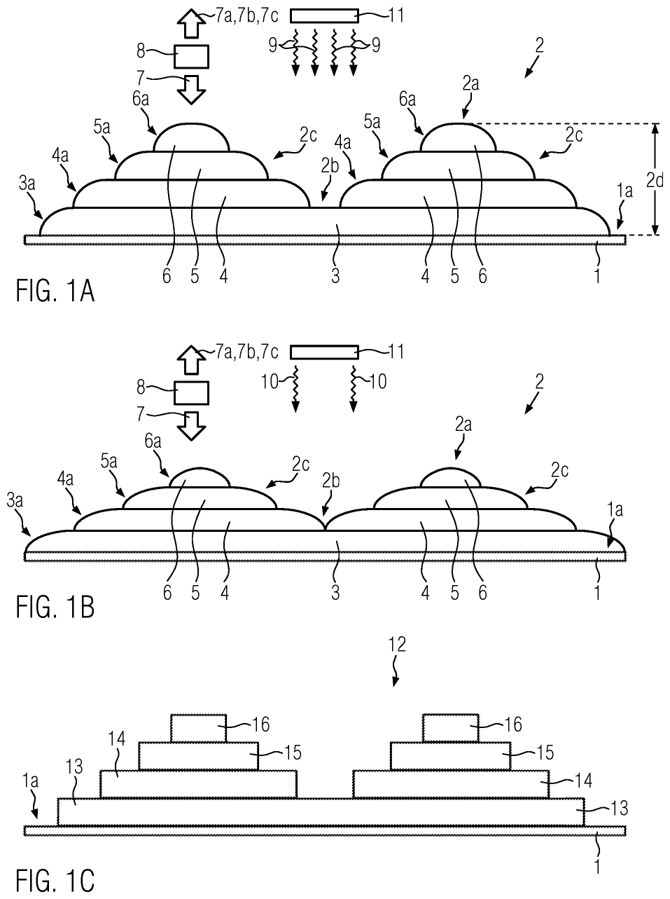

FIGS. 1A and 1B show schematically and by way of example an embodiment of a method according to the present disclosure for radiation-cured relief printing onto containers 1, in which a relief-like printed image 2 with at least two (in the example four) superimposed print layers 3 to 6 is applied to a surface 1a of a container 1, for example, on a side wall, by jet-shaped layer application 7 of at least an ink 7a, a varnish 7b, and/or similar printing paint 7c from at least one print head 8 and cured by way of irradiation 9, 10 from at least one radiation source 11 such that edge regions 3a to 6a of applied print layers 3 to 6 can run over one another and/or alongside one another.

Respective print head 8 can in principle be designed for only one ink 7a, one varnish 7b, and/or similar printing paint 7c. However, respective print head 8 can also be supplied with at least two identical and/or different inks 7a, varnishes 7b, and/or similar printing paints 7c and eject them in a suitable manner.

Print layers 3 to 6 build up relief elevations 2a and optionally also relief depressions 2b of printed image 2 in this manner. Print layers 3 to 6 respectively permitted to run until and during pinning leads to three-dimensional smoothing of printed image 2, in particular on relief flanks 2c of printed image 2.

In comparison thereto, FIGS. 1A and 1B illustrate print layers 3 to 6 that have run to a different extent and therefore relief elevations 2a (embossings), relief depressions 2b (debossings), and relief flanks 2c that are smoothed to a different extent, which, after initially identical layer application 7, result from different irradiations 9, 10 and therefore respective different initial pinning of print layers 3 to 6.

The result after separate irradiation 9 of print layers 3 to 6 is indicated by way of example in FIG. 1A. Since print layers 3 to 6 applied immediately beforehand can then only run to a relatively small extent outwardly and toward surface 1a of container 1, this results in comparatively thick print layers 3 to 6 with comparatively steep and clearly stepped relief flanks 2c of relief elevations 2a or relief depressions 2b, respectively.

In contrast, FIG. 1B shows by way of example the result after a first joint irradiation 10 of lower two print layers 3 and 4 and a second joint irradiation 10 of upper two print layers 5 and 6. According thereto, print layers 3 to 6 can then run to a larger extent until the respective pinning than with their separate irradiation 9, resulting in thinner print layers 3 to 6 and stepped relief flanks 2c of relief elevations 2a or relief depressions 2b being flatter and less pronounced.

The radiation-induced partial curing, also referred to as pinning, can be used to selectively change both height 2d of resulting relief elevations 2a as well as the contour of relief flanks 2c and in particular their stepping. For this purpose, both the intensity and duration of respective irradiation 9, 10 can be adapted in a selective manner, as can the sequence of individual steps for layer application 7 (printing processes) and for associated irradiation 9, 10 (pinning).

Print layers 3 to 6 could be irradiated and pinned individually, i.e. after each layer application 7, or only after every second, third, fourth, or fifth layer application 7. In principle, it is also conceivable to configure the sequence of layer application 7 (printing process) and irradiation 9, 10 (pinning) of print layers 3 to 6 in dependence of desired height 2d, depth, and smoothing of relief elevations 2a, relief depressions 2b, and relief flanks 2c in a non-uniform manner. Certain print layers 3 to 6 could be irradiated and pinned individually, while others could be irradiated and cured jointly or in groups.

The number of print layers 3 to 6 shown and described is only by way of example and is used for a comprehensible illustration. In practice, in particular, a larger number of print layers 3 to 6 can be applied and irradiated and pinned as described for permitting print layers 3 to 6 to run in a controlled manner when relief-like printed image 2 is built up.

FIG. 1C schematically illustrates a layer build-up 12 of print layers 3 to 6 underlying FIGS. 1A and 1B and tapering upwardly (away from surface 1a). Layer build-up 12 can be understood to be a stack of electronic print templates 13 to 16 for individual print layers 3 to 6 and represents printed image 2 from the point of view of printer control, i.e. without print layers 3 to 6 running.

Print templates 13 to 16 define the individual print areas and the print thicknesses of print layers 3 to 6 for printed image 2 to be produced. This is indicated schematically in a lateral sectional view in FIG. 1C. Layer build-up 12 is shown in the sense of a full tone print having a uniform print thickness (layer thickness) of individual print templates 13 to 16 for print layers 3 to 6 and stepped accordingly at their (imaginary) edges 3a to 6a. This stepping is smoothed by print layers 3 to 6 running, which is selectively permitted before and during pinning. Their thickness then also reduces accordingly in the process as compared to associated print templates 13 to 16.

In addition or as an alternative, print layers 3 to 6 running until the respective pinning can also be permitted in combination with half tone printing (gray scale printing) as described. In this case, the print thickness (layer thickness) of print templates 13 to 16 would vary accordingly.

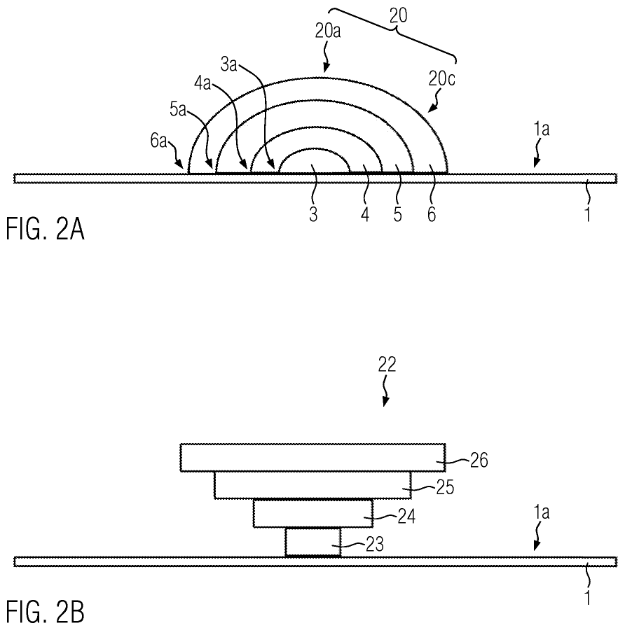

FIG. 2A shows an alternative relief-type printed image 20 with a relief elevation 20a and relief flanks 20c, where print layers 3 to 6 fully cover one another from top to bottom at their edge regions 3a to 6a in the sense of a coating. Optional relief depressions have been omitted there for reasons of clarity.

The basis for this is a layer build-up 22 shown schematically and by way of example in FIG. 2B which can be understood to be a stack of electronic print templates 23 to 26 tapering downwardly (towards surface 1a) for individual print layers 3 to 6. If print layers 3 to 6 are accordingly applied one on top of the other, then they project in the lateral direction beyond the print layer that is directly adjacent below in accordance with print templates 23 to 26 (i.e. without running). Print layers 3 to 6 are then permitted to run in the sense described above such that they cover one another in the edge regions 3a to 6a, in some embodiments, over their full height.

In this way, a relief elevation 20a with particularly smooth relief flanks 20c, for example, running substantially evenly, can be built up from print layers 3 to 6. Relief flanks 20c then possibly no longer have any visible stepping. This can be advantageous from a design perspective. On the other hand, stepped relief flanks 2c can be advantageous for tactile reasons, for example, for producing particularly non-slip printed images 2 on surface 1a of containers 1.

As indicated by FIGS. 1C and 2B schematically in the form of uniform layer thicknesses, print templates 13 to 16 and 23 to 26 can each specify full tone printing of print layers 3 to 6. In principle, however, it would also be conceivable to apply at least one of print layers 3 to 6 by half tone printing, for example, to enable color gradients and/or to already preform the contour of relief flanks 2c in edge regions 3a to 6a by way of the printer.

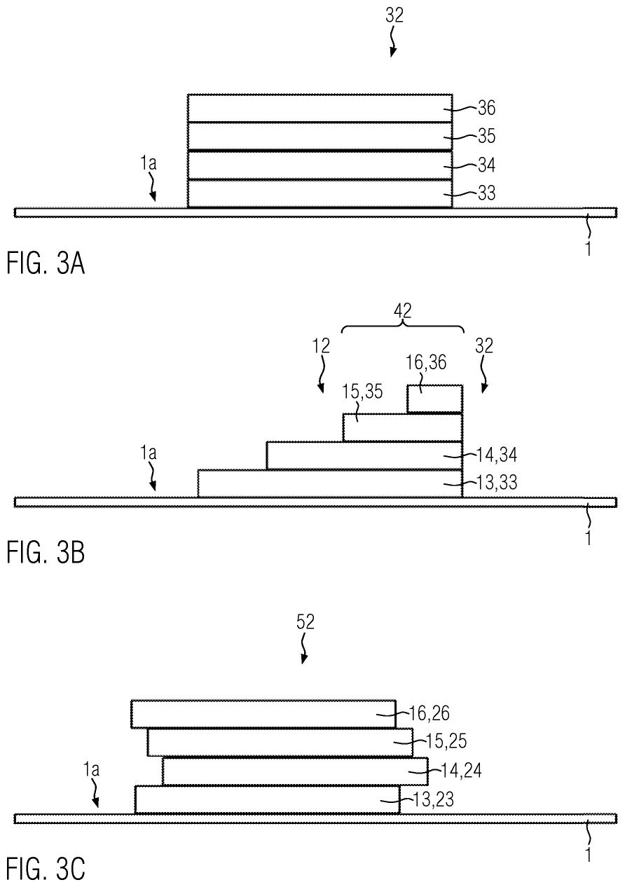

FIGS. 3A-3C indicate schematically that both a laterally aligned layer build-up 32 with print templates 33 to 36 aligned in the vertical direction at the edge is possible for forming print layers 3 to 6, as well as in principle any variants 42, 52 of the layer build-up with combinations of variants 12, 22, 32 described above of the layer build-up or associated print templates 13 to 16, 23 to 26 and 33 to 36, respectively.

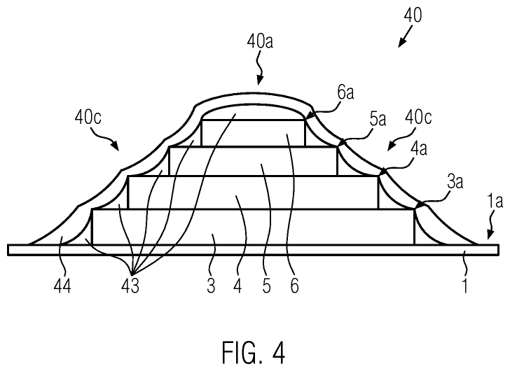

FIG. 4 shows schematically and by way of example a further variant of a method in which a printed image 40 comprising at least one relief elevation 40a and/or at least one relief depression (not shown) is produced by first printing print layers 3 to 6 one on top of the other using the full tone method in order to build up the basic and, in some embodiments, upwardly tapering contour of relief elevation 40a and associated relief flanks 40c. Edge regions 3a to 6a of print layers 3 to 6 are subsequently coated in a smoothing manner by filling and/or covering print layers 43, 44.

Accordingly, print layers 3 to 6 can build up on one another in steps at their edge regions 3a to 6a due to the full tone printing. This stepped edge profile is then, for example, smoothed at least in part filled in a smoothing manner by at least one print layer 43 and covered or coated overall by at least one print layer 44. For example, sufficient print layers 43, 44 are then applied until a desired surface smoothness of printed image 40 is obtained. The filling and covering print layers 43, 44 consist, for example, of a covering paint and/or protective varnish.

At least the filling and covering print layers 43, 44 are printed onto one another and pinned in the manner described by layer application 7 and individual and/or joint irradiation 9, 10 such that they can run at step-shaped edge regions 3a to 6a of adjacent or underlying print layers 3 to 6.

A smoothing running of print layers 3 to 6 (which fundamentally build up the contour of relief elevations 40a and/or relief depressions in full tone printing) can in principle also be permitted in the manner described or omitted or suppressed in favor of a faster and/or higher contour build-up of relief elevations 40a. The latter is indicated schematically in FIG. 4 by sharp-edged steps at partially pinned edge regions 3a to 6a.

Irrespective of whether individual print layers 3 to 6, 43 and 44 are applied using half tone methods (greyscale printing) or a full tone method (black and white printing), the respective thickness of print layers 3 to 6, 43 and 44 and therefore the height of overall resulting relief-like printed image 2, 20, 40 can be selectively influenced overall by the parameterization of irradiation 9, 10 and the resulting pinning of print layers 3 to 6, 43 and 44.

The more intense and/or longer and/or the more frequent the irradiation in relation to the number of print layers 3 to 6, 43 and 44, the faster the individual print layers 3 to 6, 43 and 44 are pinned, whereby inks 7a, varnishes 7b, or similar printing paints 7c applied can run less pronounced. This results in a greater layer thickness and in a sharper printed image and thereby in steeper relief flanks 2c, 20c, 40c of relief elevations 2a, 20a, 40a or relief depressions 2b, respectively.

For example, minimum pinning after every second, third, or fourth print layer 3 to 6, 43 and 44 could in principle be sufficient for practicable processing of inks 7a, varnishes 7b, and/or printing paints 7c. By contrast, more frequent irradiation and pinning of individual print layers 3 to 6, 43 and 44 could result in a relief elevation 2a, 20a, 40a with a greater height and/or of fewer print layers 3 to 6, 43 and 44. Conversely, the steepness and stepping of relief flanks 2c, 20c, 40c can be reduced in a selective manner by a reduction in irradiation 9, 10 that is permissible in terms of process technology and relief-like printed image 2, 20, 40 can thus be smoothed.

In addition, the height and contour of relief elevations 2a, 20a, 40a, relief depressions 2b, and relief flanks 2c, 20c, 40c can be influenced by the viscosity and/or the flow behavior of inks 7a, varnishes 7b, and/or printing paints 7c used as well as by the printing speed. The more viscous inks 7a, varnishes 7b, and/or printing paints 7c used are, the higher and more sharply defined the resulting relief elevations 2a, 20a, 40a and optionally relief depressions 2b are, and vice versa.

The higher the printing speed and/or the relative speed of surface 1a to be printed on is, the faster print layers 3 to 6, 43 and 44 can be irradiated and pinned, which in turn means that the thickness of print layers 3 to 6, 43 and 44 cannot decrease that much can and they are defined to be sharper at their edge regions 3a to 6a.

If containers 1 are rotated during the layer application and pinning (and in between), the centrifugal forces that arise there cause print layers 3 to 6, 43 and 44 applied to run less pronounced and thereby cure to be thicker and with sharper edge boundaries.

The overall thickness of relief elevations 2a, 20a, 40a produced can be set primarily by the number of print layers 3 to 6, 43 and 44 applied. In addition, inks 7a, varnishes 7b, and/or printing paints 7c can be specifically selected with regard to their viscosity and/or their flow behavior. The ejection temperature, the ejection speed, and the size (volume) of the ejected droplets can also be specifically set for the respective inkjet printing.

The viscosity of inks 7a, varnishes 7b, and/or similar printing paints 7c used is, for example, in the range from 1 to 40 mPas at 20° C. In principle, however, the use of highly viscous inks 7a, varnishes 7b, printing paints 7c with viscosity values of 40 to 400 mPas is also conceivable. The ejection temperatures in inkjet printing are, for example, between 35 and 60° C. Practical printing speeds are, for example, in the range from 200 to 1500 mm/s. A method described herein is possible, for example, with print resolutions of 75 to 1440 dpi. The droplet size can be set, for example, to a volume of 3 to 300 pL. The ejection speed of the ink droplets can be, for example, 3 to 13 m/s.

For example, light in the wavelength range from 10 to 460 nm is suitable for the irradiation 9, 10. Alternatively, irradiation 9, 10 from an electron source is possible.

A method described herein can be used, for example, in the following context:

In order to improve the surface properties, surfaces 1a of containers 1 are generally pretreated before print layers 3 to 6, 43 and 44 are applied. In the case of plastic containers, for example, plasma, corona, or possibly also flame treatment methods can be used for this purpose. Glass containers are typically silanized and flame treated, for example, in one or more steps and/or using several burners. Surfaces 1a to be printed on can also be cleaned at the same time and/or pre-coatings from glass production, for example, a cold finish, can be removed at the same time. Metal containers, such as cans, are typically pretreated by plasma or flame treatment. They can be unpainted or primered.

In order to ensure sufficient stability of print layers 3 to 6, 43 and 44 applied, a bonding agent, also referred to as a primer, can be applied onto glass surfaces 1a. Spraying processes are common for this. Instead, an application using an inkjet print head would also be possible in principle.

In the case of transparent, semi-transparent, or colored containers 1, a first print layer 3 with white ink may be printed over the entire surface or partially as the base layer in order to prevent colors from showing through on the back side and at the same time to increase the contrast of the print. This may not be necessary on white or otherwise light-colored container materials.

Print layers 3 to 6 then also generally comprise multicolored printing paints 7c which are printed digitally, for example, as part of the CMYK color model and/or as special colors.

To protect multicolored print layers 3 to 6, for example, when handling container 1 in production, during pasteurization, or in later use, a varnish 7b (protective varnish) is typically applied. It is typically printed digitally in the last step over all print layers previously applied. This is particularly common with rigid container walls. Permanently flexible protective varnishes are optionally available for flexible container walls, such as those made of plastic material.

In order to produce haptic surface features, for example, relief elevations 2a, 20a, 40a and optionally relief depressions 2b, it is possible to apply a single print layer 3 to 6, 43 and 44, for example, using Xaar High Laydown Technology and/or using high-viscosity varnish, but also in several layers, for example, 4 to 16 layers, which are printed one on top of the other. In principle, a significantly larger number of print layers is possible which in practice is limited substantially only by the printer control/software and/or design of the printing device. Such layer application 7 is possible with varnishes 7b, in particular the protective varnishes mentioned above. Print layers 3 to 6, 43 and 44 containing pigments (color layers such as white, CMYK and special colors) can in principle also be used, depending on the layer thickness that is possible with them.

To improve the print quality and spreading of the system colors used, an underprint varnish can be applied as a so-called pre-varnish before the application of the white base paint or after the application of the primer, for which purpose a protective varnish is suitable in principle and therefore same varnish 7b with which relief elevations 2a, 20a, 40a and relief depressions 2b can be produced.

Irradiation 9, 10 for pinning print layers 3 to 6, 43 and 44 can in principle take place between and/or after layer application 7 of individual print layers 3 to 6, 43 and 44. Final curing of all print layers 3 to 6, 43 and 44 typically also takes place after the application of respective uppermost print layer 6, 44, for example, with an LED UV lamp or with a mercury vapor lamp.

Inks 7a, varnishes 7b, and/or similar printing paints 7c that cure by way of UV light are typically composed of binding agents, monomers, photoinitiators, fillers, and additives, such as defoamers, running additives, thickeners, dispersing additives and/or matting agents. As is known, pigments are admixed for coloring.

The binding agents contained in UV-curing inks 7a, varnishes 7b, and similar printing paints 7c are composed substantially of monomers and pre-polymers, typically acrylate compounds. With the aid of the photoinitiators admixed, the liquid acrylate compounds react under the influence of UV light to form a solid plastic film. The photoinitiators are additives for UV-curing inks 7a, varnishes 7b, and similar printing paints 7c. As a result of light absorption, the photoinitiators produce reaction products (radicals) that lead to crosslinking in the binding agent.

Alternatively, initiators for radiation-curing inks 7a, varnishes 7b, and/or similar printing paints 7c are known and trigger comparable reactions when exposed to electron beams.

It is to be understood that the above description is intended to be illustrative, and not restrictive. Other embodiments will be apparent upon reading and understanding the above description. Although embodiments of the present disclosure have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

1. A method for printing a radiation-cured relief image onto a container, comprising:
printing a plurality of print layers onto a container by way of an ink jet
wherein the plurality of print layers are applied one on top of another onto a surface of said container by way of the ink jet and are cured successively by way of irradiation in such a way that said plurality of print layers can one or more of run over one another or run alongside one another.

2. The method according to claim 1, wherein at least two print layers are applied to said container surface one on top of another by way of the ink jet and are one or more of cured individually and/or or cured jointly by way of irradiation in such a way that one or more edge regions of said plurality of print layers can one or more of run over one another or run alongside one another.

3. The method according to claim 1, wherein at least one of said plurality of print layers are applied by full tone printing.

4. The method according to claim 1, wherein a first edge region of a first print layer projects laterally over a second edge region of a second print layer disposed directly beneath the first print layer according to an associated electronic print template and wherein said first edge region is permitted to run towards said container surface in such a way that the first edge region covers said second edge region in a full height of the second edge region.

5. The method according to claim 1, wherein, in dependence of one or more respectively associated electronic print templates, said plurality of print layers form at least one relatively low printed image region with at least one print layer and at least one relatively high printed image region with a comparatively larger number of print layers, the at least one relatively high printed image region forming one or more of a relief elevation or a relief depression.

6. The method according to claim 1, wherein at least one of said plurality of print layers is a paint layer and at least one of said plurality of print layers is a protective varnish layer.

7. The method according to claim 1, wherein one or more irradiation durations for one or more steps of a respective pinning of one or more of said plurality of print layers are parameterized separately for each individual step of the one or more steps.

8. The method according to claim 1, wherein said plurality of print layers are pinned by irradiation with light in a wavelength range from 10 to 460 nm.

9. The method according to claim 1, wherein one or more time intervals between a layer application and an associated irradiation of said plurality of print layers are set by adapting a relative speed of said container surface with respect to one or more print heads associated with said plurality of print layers and one or more radiation sources.

10. The method according to claim 1, wherein said container is rotated about itself during a layer application and an irradiation of said plurality of print layers, and a rotational speed for said irradiation is adapted to one or more of a viscosity or a flow behavior of an ink, a varnish, or a printing paint that is applied.

11. The method according to claim 1, wherein said plurality of print layers each have a thickness of 1 μm to 200 μm, and wherein a total layer thickness after curing is 1 μm to 10 mm.

12. The method according to claim 1, wherein one or more thicknesses of said plurality of print layers are set by one or more of:
adapting at least one of a viscosity, a surface tension, an ejection temperature, an ejection speed, or a droplet size at ejection of an ink, a varnish, or a printing paint used to create the relief image;
adapting one or more of a curing rate or a curing duration per dose of irradiation; or
adjusting a time interval between a layer application and an associated irradiation.

13. The method according to claim 1, wherein said plurality of print layers are applied during a continuous transport of said container by way of at least one print head which is stationary in relation to the container.

14. A container for receiving liquid end products such as food, with the container comprising a relief-like printed image comprising a plurality of print layers applied using a method comprising:
printing the plurality of print layers onto the container by way of an ink jet
wherein the plurality of print layers are applied one or top of another onto a surface of said container by way of the ink jet and are cured successively by way of irradiation in such a way that said plurality of print layer can one or more of run over one another or run alongside one another.

15. The method according to claim 1, wherein at least two of said plurality of print layers are applied by full tone printing.

16. The method according to claim 1, wherein one or more irradiation intensities for one or more steps of a respective pinning of one or more of said plurality of print layers are parameterized separately for each individual step of the one or more steps.

17. The method according to claim 1, wherein said plurality of print layers are pinned by way of an electron beam.

18. The method according to claim 1, wherein one or more time intervals between a layer application and an associated irradiation of said plurality of print layers are set by including an idle rotation between said layer application and said associated irradiation.

19. The method according to claim 10, wherein the rotational speed for said irradiation is adapted separately from the rotational speed during jet application.

20. The method according to claim 1, wherein said plurality of print layers each have a thickness of 10 μm to 125 μm, and wherein the total layer thickness after curing is 20 μm to 1 mm.
